(19) United States
(12) Patent Application Publication
(10) Pub. No.: US 2007/0263805 A1
(43) Pub. Date: Nov. 15, 2007

(54) Method to alert participant on a conference call

(76) Inventor: Christopher F. McDonald, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/416,350

(22) Filed: May 1, 2006

(51) Int. Cl. H04M 11/00

(52) U.S. Cl. 379/93.26

(57) ABSTRACT

A method, system and computer program product for enhancing a telephone device to alert a user of the device when his/her presence is requested by another participant to a telecommunication occurring between the user on the device and other participants on other devices. The device is programmed with voice recognition capability, which the user is able to train to recognize specific key words or phrases originating from/during the telecommunication. When one of the specific key words or phases is spoken, the device provides an alert that informs/alerts the user that the word or phase was spoken. The user may then provide a reaction/response to that occurrence without having to listen in to the entire prior conversation.

### BACKGROUND OF THE INVENTION

1. Technical Field

The present invention relates generally to telephone systems and in particular to programmable functions on telephone systems. Still more particularly, the present invention relates to programmable functions activated during ongoing telecommunication on telephone systems.

2. Description of the Related Art

A growing number of conventional telephone systems are designed with programmable functions. These functions may be accessible via button on the phone device or in more advanced devices, via selectable menu with user-selectable programming options. In the business environment, and frequently with personal calls as well, a person is requested to participate in (or attend) a conference call involving other parties on other telecommunication devices (phones).

Frequently, people are asked to be on a conference call, but not as an active participant. These inactive participants may only on the call in case a question arises in their area of expertise, for example. When the inactive participant's device provides a speaker phone function, the participant typically places the call on speaker so they may access other documents and take notes, etc., while still on the call. Often, conference calls lasts several hours, and typically the inactive participants turn down (or mute) the volume on their phone and proceed with completing other tasks/work.

The other participants on the call assume the inactive participant is paying attention and may occasionally request input from the inactive participant. With the volume turned down or muted and his/her mind focused on the other task, the in-active participant, who is not paying close attention to what is happening/being discussed on the call, may not notice when a question is asked of (directed to) him/her. This may lead to an embarrassing moment for the inactive participant and perhaps others on the conference, as the inactive participant is “outed” as not paying attention to what others may consider an important conversation. The repeated “hello ‘NAME’ are you there???“or similar question followed by a silent pause before the inactive participant recognizes he is being address may be a bit embarrassing, to say the least. Even the inactive participant wishes to project that he/she has good “phone conferencing” etiquette by not merely pretending (by his/her apparent “presence” on the call) to be listening.

### SUMMARY OF THE INVENTION

Disclosed is a method, system and computer program product for enhancing a telephone device to alert a user of the device when his/her presence is requested by another participant to a telecommunication occurring between the user on the device and other participants to the telecommunication on other devices. The device is programmed with voice recognition capability, which the user is able to train to recognize specific key words or phrases originating from/during the telecommunication. When one of the specific key words or phases is heard over the telecommunication, the device provides an alert that informs the user that the word or phase was spoken. The user may then provide a reaction/response to that occurrence without having to listen in to the entire conversation occurring on the telecommunication.

In the conference call scenario, this mechanism allows the user to give his full attention to his other task/work and still respond to questions from the conference call promptly, if they come up and are addressed to him/her. The mechanism also allows the user to turn the volume of his phone down lower than usual or mute it completely, causing less distraction to nearby co-workers or to the user.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 illustrates a telephone network with multiple phone devices participating in a conference call in accordance with one embodiment of the invention;

FIG. 2 illustrates one configuration of the internal components of an example phone device within which the features of the invention may be implemented according to one embodiment; and

FIG. 3 is a flow chart of the process by which the voice recognition and in-call response features of the invention are performed in accordance with one embodiment of the invention.

### DETAILED DESCRIPTION OF AN ILLUSTRATIVE EMBODIMENT

The present invention provide a method, system and computer program product for enhancing a telephone device to alert a user of the device when his/her presence is requested by another participant to a telecommunication occurring between the user on the device and other participants to the telecommunication on other devices. The device is programmed with voice recognition capability, which the user is able to train to recognize specific key words or phrases originating from/during the telecommunication. When one of the specific key words or phases is heard, the phone device provides an alert that informs the user that the word or phrase was spoken. The user may then provide a reaction/response to that occurrence without having to listen in to the entire conversation occurring on the telecommunication.

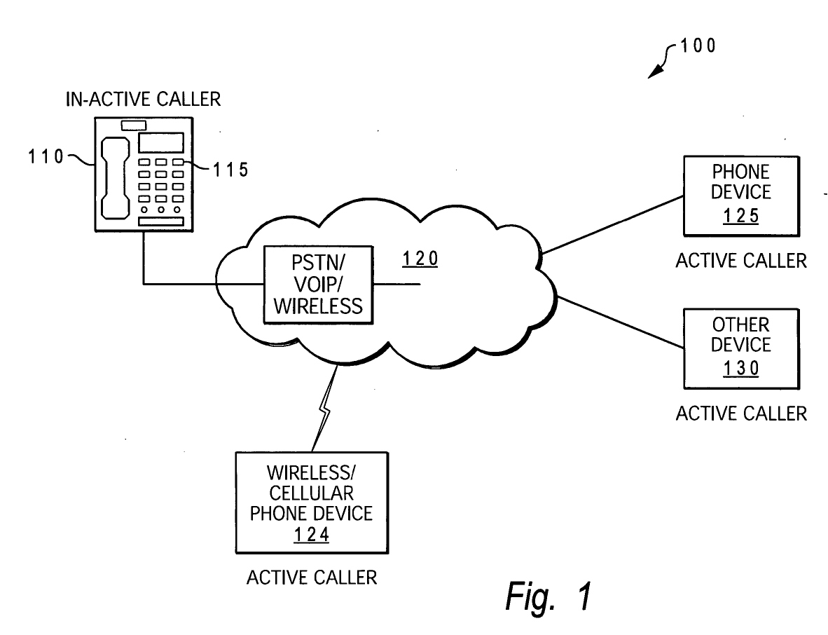

Referring now to the figures and in particular to FIG. 1, wherein is illustrated an example telephone network within which a conference call is being conducted according to one embodiment. Telephone network 100 may be a PSTN (public switched telephone network) or VOIP (Voice over IP) network or a wireless network, or a combination of two or more of the different types of network. As shown, multiple end-user devices are coupled to telephone network and are involved in a single conference call with each other. These end-user devices include phone devices 115 and 125, wireless/cellular phone device 127, and other communication devices 130. In the illustrative embodiment, phone device 125, wireless/cellular phone device 127, and other communication devices 130 are illustrated as active devices, i.e., devices of persons on the conference call that are actively engaged in the ongoing conference call. However, phone device 115 is illustrated as being inactive, which indicates that the user of phone device 115 is not actively engaged in the conference call and may have placed phone device 115 in a low volume or mute operating mode. For purposes of the illustration, the features described herein are described as being implemented within phone device 115 of an “inactive” user on the conference call. However, it is understood that the features described may apply to any one of the devices (125/127/130) that may be involved in the phone telecommunication.

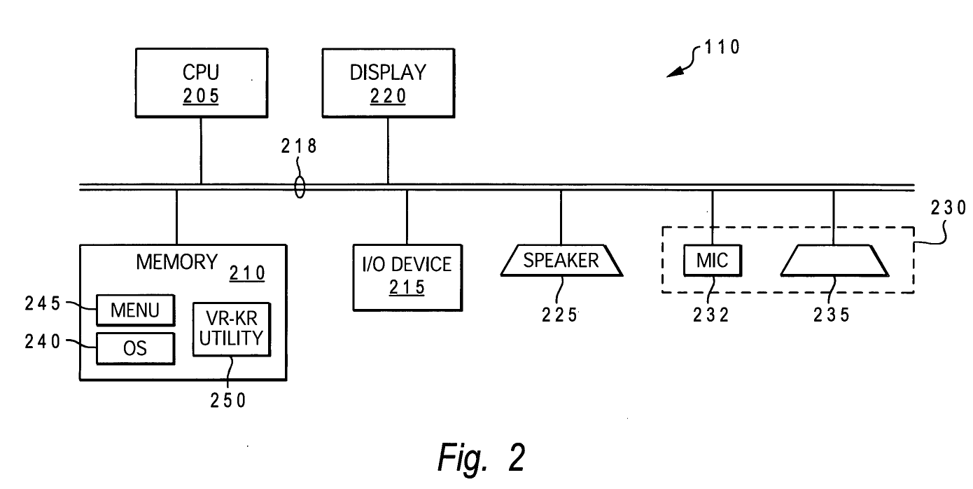

FIG. 2 illustrates an example configuration of phone device 115 complete with functional components required to provide the features of the invention. Phone device 115 is assumed to be a programmable device with processing capabilities. Thus phone device 115 comprises a processor (or CPU) 205 coupled to memory 210 via a bus interface 218. Also coupled to bus interface 218 are a display device 220, an I/O device 215 (such as numeric and function keyboard), a speaker 225 that enables speakerphone options, and a headset 230, which includes a microphone 232 and a smaller speaker 230. In one embodiment, I/O device 215 includes a conference button 115 (FIG. 1), with functionality as described below. Also, I/O device 215 also includes a menu button that enables user-access to functionality provided by a standard menu utility and other software coded functions.

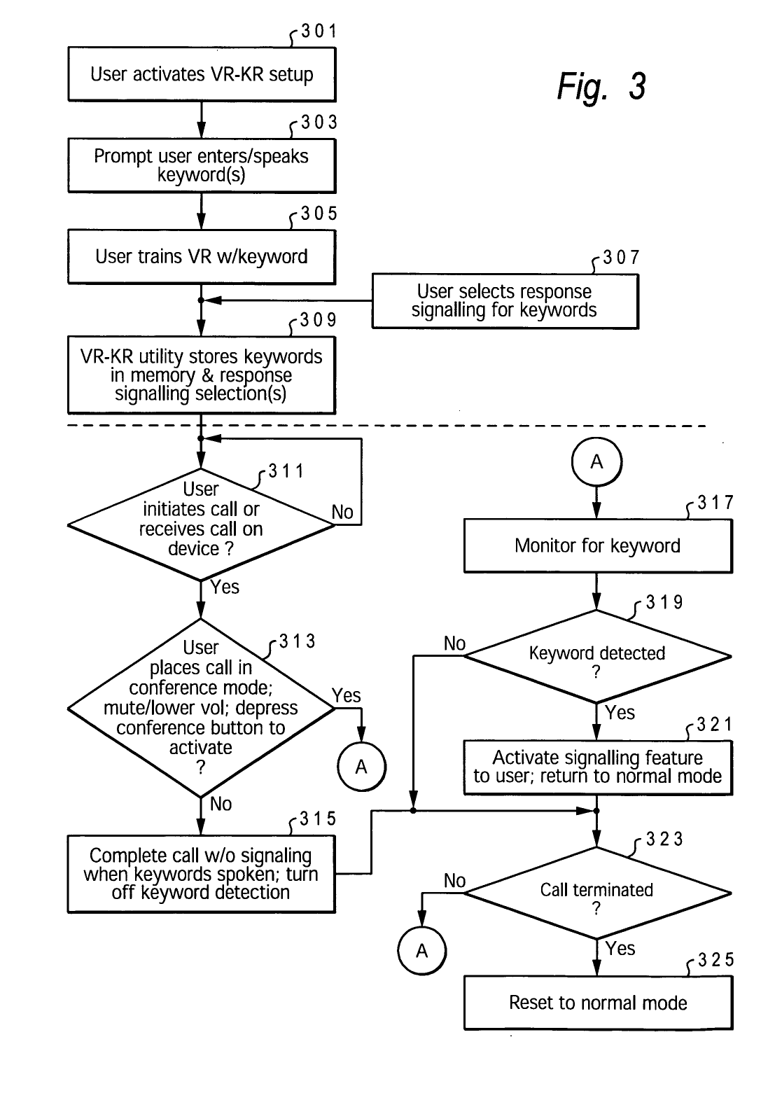

Located within memory 260 and executed on processor 250 are a number of software components, including operating system (OS) 240 and a plurality of software applications, including menu utility 245 and voice recognition and key word response (VR-KR) utility 250. VR-KR utility 250 is illustrated as a separate component from menu utility 245, but may be a sub-component of menu utility 245. Menu utility 245 when executed, enables access to the standard menu options found in programmable phones, such as voicemail setup and access, speed dial setup, and others. According to the invention, menu utility 245 also comprises an option to setup conference calling features for the phone 110. When this option is selected, menu utility activates VR-KR utility to enable the user to train the phone perform a series of functions including: (1) to recognize specific keywords and/or phrases; (2) to recognize when to initiate monitoring for these keywords (e.g., during a conference call when the user places the phone on mute or lowers the volume below a threshold level); to respond to the occurrence of the keyword/phrase with a specific signal to the user; and (4) to automatically resume normal mode operation (i.e., un-muted and standard volume level) once the user is signaled; and other features/functionality described below and illustrated by FIG. 3.

In one embodiment, the telephone device is pre-programmed with the voice recognition ability and pre-set signaling features during manufacture, and the phone is bought off-the-shelf with this pre-programmed functionality. In another embodiment, using more advanced phone devices/mechanisms, the functionality is programmed into the phone post-manufacture by the end user or service provider. This latter embodiment applies in particular to VOIP phones, which maybe enhanced with a later-added software package on a desktop computer or similar device supporting VOIP.

FIG. 3 illustrates the process steps completed by the above described pre-processor function, according to one embodiment. The process involves a setup phase and an application phase, separated by dashed lines in the figure. As shown at block 302, the process begins when the user activates the VR-KR utility setup. The VR-KR utility then provides the various prompts for the user to enter/speak the keywords, as provided at block 304. The user then enters the keywords and trains the voice recognition component at block 305. Then, the user also selects the response desired when the keyword is heard (as well as the context in which the keyword monitoring should be implemented, etc), as indicated at block 307. Finally, during this setup phase the VR-KR utility stores the keywords and the response selection(s) in memory.

With the above process, the user of the phone/software may train the voice recognition software with his name, including variations thereof (e.g. Bob, Robert, Russell, Dr. Russell, Mr. Russell). Then, during a conference call, for example, the software will recognize whenever one of the user's names is spoken in the incoming voice traffic. The user may also program the type of alert for the specific name heard, and when the name is heard, the software triggers a response including the specific kind of alert programmed (or the alert available, if not programmable).

The utility operates differently from a telephone menu that has prompts and a limited set of input that it expects after each prompt. Because the software is receiving a continuous stream of audio and has no idea when to expect one of the keywords, the user may also program other functions related to the keywords/phases. For example, the software may be programmed to recognize repeated phases/words, which indicates the speaker is stressing the word or making a point of relevance. This functionality is also programmed in because of an observed/recorded characteristic of human speech patterns that people will generally repeat someone's name if the person addressed does not answer a question promptly.

In one embodiment, therefore, the system is provided with a first low threshold for detecting the keywords in general. After the system has detected a keyword once, the system may then turn on a higher threshold check and listen for the keywords again in the next several seconds. Only if the system hears a keyword repeated again will the system consider that first occurrence to be a “real” keyword.

In one embodiment, to sufficiently train the software to recognize the key phrases/words when spoken with different accents and inflections, the user is able to input other voices other than the user's own voice and record those other voices (e.g., by enlisting the help of friends and co-workers), preferably with varying accents/tone. In another embodiment, the software may be activated to self-train using a pre-recorded conference call where the keywords are present. In one implementation of this embodiment, the user will need to indicate what intervals of the recording correspond to particular keywords.

During the active call phase, which begins at block 311, the VR-KR utility is activated when the user initiates a call or receives (and answers) a call. When this occurs, the VR-KR utility determines at block 313, via one of several possible mechanisms/methods whether the user places the call in conference mode. In one embodiment, the user may place the call in conference mode by depressing a conference button (e.g., button 115) on the device. In another embodiment, the VR-KR utility dynamically determines when the conference mode is triggered based on other indirect actions of the user. For example, the utility determines the user has entered into conference mode whenever the user mutes the phone during a conversation or whenever the user lowers the volume on the phone below a pre-established threshold. If the call is not placed on conference mode then the call is made to complete without every activating the signaling mode of the VR-KR utility, as shown at block 315. Notably, also, in this scenario, the keyword/phrase detection functionality may be turned off so that the user does not get interrupted with signaling when the user is not on a call that requires signaling.

When the call is placed in conference mode, the VR-KR utility begins monitoring for the keyword(s)/phrase(s), as depicted at block 317, and a determination made at block 319 whether a keyword/phrase is detected. If a keyword/phrase is detected, the VR-KR activates the pre-set signaling feature at block 321. According to the illustrated embodiment, this feature also involves a return to normal operation mode (e.g., un-mute and increase volume level).

In one embodiment, when the voice recognition software decides it has heard one of the keywords (e.g., the phone user's name) the software signals the user with one or more of the following alerts, depending on how the response mechanism function is configured: (1) increase the volume of the conference call to a preset level; (2) display a visual alert (e.g. a flashing light) on an LED of the phone; (3) generate an audio alert (e.g. a beep). Additionally, the response mechanism may also provide one or more of the following functions: (4) replay the previous n seconds of the conference call at a louder volume on a separate audio channel from the rest of the conference call.

Once one or more of these response mechanisms are activated, the user may then choose how to respond. In one embodiment, the above described features are incorporated into a cell phone, so that a person's cell phone is set to listen in on a call (on another phone device) while the user does something else. The cell phone will then alert the user only when his/her name is mentioned.

Returning to FIG. 3, following the implementation of the signaling feature and the user response thereto, a determination is made at block 323 whether the call has ended or been terminated, and if so then the phone is reset to normal operating mode. If the call is not terminated, however, the VR-KR utility continues to monitor for the occurrence of a keyword/phrase.

In the conference call scenario, this mechanism allows the user to give his full attention to his other task/work and still respond to questions from the conference call promptly, if they come up and are addressed to him/her. The mechanism also allows the user to turn the volume of his phone down lower than usual or mute it completely, causing less distraction to nearby co-workers or to the user.

In one embodiment, the invention capitalizes on algorithms that enable recognition of a particular word when spoken by an arbitrary voice (for example in voice recognition based menu systems that recognize numbers and responses such as “yes/no”, see U.S. Pat. Nos. 5,020,107 and 4,763,278, for example. However, the recognition features of the invention relate specifically to user-programmed recognition of particular audio signals received by the device during a conference call, and more specifically to the responses provided to alert the user when those pre-set audio signals are received/heard.

In another embodiment, the system only looks for the keyword after a significant pause, since people will usually pause when waiting for a response before repeating the question or the person's name. Recognizing that simply looking for the pause itself, would likely produce too many false positives, in yet another embodiment, the system also looks for other cues around the keyword, such as a rising tone at the end of the statement, suggesting/indicating a question was asked. As voice recognition software and the available processing power for voice recognition improve, these workarounds may be removed and a simple one-pass check for the keywords can be implemented in the system.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a telephone device, a method comprising:
connecting the phone device to another device to conduct a telephone communication;
placing the phone device in a first operating state when the user of the phone device does not wish to be an active participant within the telephone communication;
dynamically monitoring for an voicing of a keyword by another participant to the telephone communication speaking on the another device; and
when the keyword is detected by the phone device, automatically alerting the user that the keyword has been detected, wherein the user is able to selectively become an active participant to the telephone communication.

2. The method of claim 1, said automatically alerting step further comprising:
automatically changing the setting of the phone device to a second operating state in which the user is able to be an active participant within the telephone communication.

3. The method of claim 1, wherein said monitoring comprises:
activating a voice recognition software when the phone is placed in the first operating state; and
checking each word heard during the telephone communication against a pre-established list of keywords for a match.

4. The method of claim 3, wherein said checking comprises:
initiating a pre-set response for the particular keyword detected when there are multiple pre-established keywords with different associated responses.

5. The method of claim 3, further comprising:
enabling user-selection and setting of the pre-established list of keywords; and
when there are multiple pre-established keywords with granularly associated responses, enabling user-selection of a particular response to associate with each of the pre-established keywords.

6. The method of claim 1, said alerting further comprising:
increasing the volume of the telephone communication to a preset level;
displaying a visual alert on the device, such as a flashing light on an LED of the phone; and
generating an audio alert from the device.

7. The method of claim 6, further comprising:
activating a background replay of a previous n seconds of the telephone communication on a separate audio channel from the rest of the telephone communication.

8. The method of claim 1, wherein the telephone communication is a conference call.

9. A computer program product for utilization within a digital phone device, said program product comprising:
a computer readable medium; and
program code on the computer readable medium for:
connecting the phone device to another device to conduct a telephone communication;
placing the phone device in a first operating state when the user of the phone device does not wish to be an active participant within the telephone communication;
dynamically monitoring for an voicing of a keyword by another participant to the telephone communication speaking on the another device; and
when the keyword is detected by the phone device, automatically alerting the user that the keyword has been detected, wherein the user is able to selectively become an active participant to the telephone communication.

10. The computer program product of claim 9, said code for automatically alerting further comprising code for:
automatically changing the setting of the phone device to a second operating state in which the user is able to be an active participant within the telephone communication.

11. The computer program product of claim 9, wherein said code for monitoring comprises code for:
activating a voice recognition software when the phone is placed in the first operating state; and
checking each word heard during the telephone communication against a pre-established list of keywords for a match.

12. The computer program product of claim 11, wherein said code for checking comprises code for:
initiating a pre-set response for the particular keyword detected when there are multiple pre-established keywords with different associated responses.

13. The computer program product of claim 11, further comprising code for:
enabling user-selection and setting of the pre-established list of keywords; and
when there are multiple pre-established keywords with granularly associated responses, enabling user-selection of a particular response to associate with each of the pre-established keywords.

14. The computer program product of claim 9, said code for alerting further comprising code for:
increasing the volume of the telephone communication to a preset level;
displaying a visual alert on the device, such as a flashing light on an LED of the phone; and
generating an audio alert from the device.

15. The computer program product of claim 14, further comprising code for:
activating a background replay of a previous n seconds of the telephone communication on a separate audio channel from the rest of the telephone communication.

16. The computer program product of claim 9, wherein the telephone communication is a conference call.

17. A telephone device comprising:
a processor;
a memory device having stored therein a utility that when executed performs the functions of:
detecting when the phone device is connected to another device to conduct a telephone communication;
placing the phone device in a first operating state when the user of the phone device does not wish to be an active participant within the telephone communication;
dynamically monitoring for an voicing of a keyword by another participant to the telephone communication speaking on the another device;
when the keyword is detected by the phone device, automatically alerting the user that the keyword has been detected, wherein the user is able to selectively become an active participant to the telephone communication; and
automatically changing the setting of the phone device to a second operating state in which the user is able to be an active participant within the telephone communication.

18. The telephone device of claim 17, said utility further comprising code that provides the functions of:
enabling user-selection and setting of the pre-established list of keywords; and
when there are multiple pre-established keywords with granularly associated responses, enabling user-selection of a particular response to associate with each of the pre-established keywords;
activating a voice recognition software when the phone is placed in the first operating state;
checking each word heard during the telephone communication against the pre-established list of keywords for a match; and
initiating the pre-set response for the particular keyword detected when there are multiple pre-established keywords with different associated responses.

19. The telephone device of claim 17, said utility further comprising code that provides the functions of:
concurrently with said alerting, completing one or more of the following:
increasing the volume of the telephone communication to a preset level;
displaying a visual alert on the device, such as a flashing light on an LED of the phone; and
generating an audio alert from the device.
activating a background replay of a previous n seconds of the telephone communication on a separate audio channel from the rest of the telephone communication.

20. The telephone device of claim 17, further comprising:
a selectable button that when depressed by the user activates the utility and places the phone in the first operating state; and
means for enabling user-programming and training of the pre-established keywords and the associated response to each pre-established keyword.
